(19) United States
(12) Patent Application Publication
(10) Pub. No.: US 2024/0176849 A1
(43) Pub. Date: May 30, 2024

(54) Method for Characterizing a Test Bench and Associated Method for Testing and Producing a Component

(71) Applicant: Bayerische Motoren Werke Aktiengesellschaft, Muenchen (DE)

(72) Inventor: Jakob BONART, Olching (DE)

(21) Appl. No.: 18/549,492

(22) PCT Filed: Feb. 22, 2022
(86) PCT No.: PCT/EP2022/054303

§ 371 Date: Sep. 7, 2023

(30) Foreign Application Priority Data
Mar. 18, 2021 (DE) 10 2021 106 593.3

(51) Int. Cl. G06F 17/18

(52) U.S. Cl. CPC G06F 17/18

(57) ABSTRACT

A method for characterizing a test bench designed for measuring sound levels of components includes determining measured values which characterize respective sound levels emitted by the components at a same operating point and which are measured by the test bench, calculating a distribution function from the measured values, normalizing the distribution function, calculating a mean value of the normalized distribution function, and calculating a standard deviation of the normalized distribution function.

### BACKGROUND AND SUMMARY OF THE INVENTION

The invention relates to a method for characterizing a test bench for testing components. Furthermore, the invention relates to a method for testing at least one component and a production method.

It is known from the development of components, in particular for motor vehicles, that the components are tested. Test benches are used for this purpose. In particular in the context of mass production of components, multiple test benches can be used, so that first the components are tested by means of a first of the test benches and second the components are tested by means of a second of the test benches. At least two of the components can thus be tested simultaneously. However, the test benches can be subjected to technically related variances, so that, for example, a component that is found to be in order by means of one test bench would be found not to be in order by means of another test bench or vice versa. This can be the case in particular in test benches for measuring sound levels. It is thus conceivable that it is determined by means of a test bench that a component is sufficiently quiet to be able to be installed and used in a motor vehicle, wherein, for example, it is or would be determined by means of another test bench that the same component is excessively loud or emits undesired noises and is therefore unsuitable to be installed and used in a motor vehicle. This can be in particular because, notwithstanding their variances or differences, the same limiting value, therefore the same limit, to which the components or the sound level emitted by the component is compared, is used for the test benches. Due to the variances or differences between the test benches, it is conceivable here that, for example, it is determined by means of the one test bench that a sound level which is emitted by a component while the one component is operated at an operating point is below the limit, so that the one component is classified as sufficiently quiet and thus as in order, wherein, for example, it is or would be determined by means of another test bench that the sound level emitted by the one component at the same operating point exceeds the limit, so that the same component is classified by means of the one test bench as sufficiently quiet and thus as in order but is or would be classified by means of the other test bench as excessively loud and therefore as not in order.

The publication “Experimental round-robin evaluation of structure-borne sound source force-power test methods”, H. Kevin Lai, et al., 2015, is, for example, an evaluation of differences in or between various laboratories. For example, in the case of transmission test benches, a separate statistic is built up in each test bench and the limit is then determined on the basis thereof. For the case that the test bench results are supposed to correlate with vehicle assessments, there is only such internal prior art, that one runs a sufficient number, for example greater than 100, of transmissions or engines in two test benches to be able to form a transfer curve.

The object of the present invention is therefore to provide a method which enables components to be able to be tested by means of test benches in a sufficiently comparable manner.

A first aspect of the invention relates to a method for characterizing at least one test bench designed for measuring sound levels of components, in particular for motor vehicles. As will be explained in more detail hereinafter, the method provides a particularly advantageous foundation for determining, in particular calculating, a limiting value also designated as a first general limiting value or general limit, in order to check on the basis of the general limit sound levels emitted by the components and/or by other, further components in the same operating point, which are or were measured by means of the test bench and/or by means of another, further test bench, in particular as to whether the respective sound level is excessively high or sufficiently low, therefore to check whether the respective component is excessively loud or emits undesired noises or is sufficiently quiet or does not emit undesired noises. In particular, the method according to the invention provides a foundation in order to be able to compare results of sound level measurements carried out by means of the test benches informatively with one another, so that, for example, by means of the test benches, the same component, that is to say the sound level emitted by the same component at the same operating point, can be judged or assessed, i.e., classified, in the same way. The method according to the invention thus provides a condition so that it does not occur that the same component when it is operated at an operating point is assessed by one of the test benches as sufficiently quiet and thus as in order and by the other test bench as excessively loud and thus as not in order.

For this purpose, the method comprises a first step, in which measured values are determined, which are also designated as first measured values and which characterize the sound levels emitted by the components, also designated as first components, at the same operating point and measured by means of the test bench. The determination of the measured values can comprise that the measured values stored, for example, in a storage unit, in particular of an electronic computing unit, are retrieved from the storage unit, in particular by means of the electronic computing unit. The determination of the measured values can, but does not necessarily have to, comprise generating or acquiring the measured values. Generating or acquiring the measured values is to be understood in particular as the following: For example, the components are operated by means of the test bench, also designated as the first test bench or master test bench, in particular successively or sequentially, at the same operating point. The operating point is, for example, at least or exclusively characterized or defined by a speed, so that the respective first components, in particular sequentially or successively, are operated by means of the test bench at the same speed. In this case, for example, the respective component comprises a shaft designed in particular as an output shaft, via which the component can provide, for example, at least one torque, in particular for driving a motor vehicle. The above-mentioned speed is to be understood as a speed at which the shaft rotates in particular around an axis of rotation relative to a housing of the component. While the shaft rotates at the speed or while the shaft is rotated at the speed, by which the respective first component is operated at the respective operating point, also designated as the first operating point, the respective component emits a sound, for example a structure-borne sound and/or an airborne sound, and thus a sound level, which is measured by means of the test bench, for example by means of a sensor such as a structure-borne sound sensor and/or a microphone, of the first test bench. The sound level is thus a measured variable which is measured by means of the test bench, wherein the respective measured value is a value and thus a variable or a measure of the measured variable, so that the respective measured value is measured by means of the test bench. The respective measured value therefore characterizes or defines, for example, how loud the respective component was or is while the shaft was or is rotated at the speed, therefore while the respective component is operated at the operating point. The components can be subjected to tolerances, in particular related to production, so that the components at the same operating point, i.e., although they are operated identically or although the shaft is rotated at the same speed, can be differently loud, that is to say can emit different sound levels, which is expressed in particular in that the measured values are different from one another.

In particular, the measured values are determined by means of a or the above-mentioned electronic computing unit. The determination can comprise that the measured values, which are provided, for example, by the test bench, in particular by the sensor, are transferred to the electronic computing unit and are received by the electronic computing unit, in particular in such a way that the measured values are stored in the storage unit and are retrieved by the electronic computing unit.

In a second step of the method, a distribution function, also designated as the first distribution function, is calculated from the measured values, in particular by means of the electronic computing unit. In other words, a distribution function of the measured values is calculated. The distribution function and its calculation are well known from the general prior art and in particular from the field of stochastics. The first distribution function is also designated as the original distribution function.

In a third step of the method, the distribution function is normalized. In the scope of the invention, normalization of the distribution function is to be understood to mean that a normal distribution, also designated as a Gaussian distribution, is formed from the original distribution function, which is in particular not yet normalized. The well-known Box-Cox transformation is suitable for this purpose, for example, which makes it possible, for example, to form a or the normal distribution from a distribution or distribution function also designated as a skewed distribution, which deviates from a or the normal distribution. Due to the normalization of the distribution function, a normalized distribution function is formed from the original distribution function. The calculation of the distribution function and the normalization of the distribution function are preferably carried out by means of the electronic computing unit. The normalized distribution function is also designated as the first equal distribution or first equal distribution function.

In a fourth step of the method, a mean value of the normalized distribution function (first equal distribution function) is calculated, in particular by means of the electronic computing unit.

In a fifth step of the method, the standard deviation of the normalized distribution function, also designated as sigma, is calculated, in particular by means of the electronic computing unit. The standard deviation and the mean value characterize the first test bench, wherein components can be tested in a particularly well comparable manner by means of different test benches starting from this characterization. The standard deviation is well known from the general prior art and in particular from the field of stochastics as a dispersion measure.

It has proven to be particularly advantageous if a transformation rule comprising the standard deviation and the mean value is determined, in particular by means of the electronic computing unit, on the basis of which each point of the original distribution function is transformable into a point of the normed first equal distribution function (normalized and normed distribution function), in order to thus generate the normalized and normed distribution function from the points of the distribution function. In other words, the original distribution function is a starting system or is located in a starting system or can be observed as a starting system or in a starting system. Accordingly, the first normed equal distribution function is a target system or the first normed equal distribution function is located in a target system or the first normed equal distribution function can be observed as a target system or in a target system. By means of the transformation rule, each point or each measured value can be brought, that is to say transformed, from the starting system into the target system. The original distribution function is normalized by means of a normalization rule, which is also designated as an instrument. For example, the instrument is the above-mentioned Box-Cox transformation. In this case, for example, the transformation rule comprises the instrument, the mean value, and the standard deviation, so that, for example, each point of the original distribution function can be transformed into the target system in that the respective point is subjected to the normalization rule, and, in particular thereafter, is offset with the standard deviation and the mean value, by which the respective point is subjected to the transformation rule, therefore offset according to the transformation rule and thus converted into a corresponding point in the target system. For example, the respective point of the original distribution function is first subjected to the normalization rule, therefore offset according to the normalization rule, by which the respective point of the original distribution function is converted into a respective normalized second point of the normalized, not yet normed distribution function. The normalized, not yet normed distribution function can be normed, for example, on the basis of the standard deviation and the mean value, in particular in that the difference between the respective second point and the mean value is divided by the standard deviation. The normalized and normed distribution function is in particular to be understood to mean that at or in the normalized and normed distribution function, the mean value is 0 and the standard deviation extends from −1 to +1.

A further embodiment is distinguished in that at least one general limiting value relating to the normalized and normed distribution function is calculated as the above-mentioned general limit.

For example, the general limiting value, i.e., the general limit, is calculated in that the mean value of the normalized and normed distribution function is added to the standard deviation of the normalized and normed distribution function or a multiple of the standard deviation of the normalized and normed distribution function. The general limit is thus determined here on the basis of the normalized and normed distribution function, thus in the target system. The multiple of the standard deviation is also designated as the n-fold of the standard deviation, wherein n designates a real number, in particular a positive real number. In other words, the general limit is, for example, the mathematical sum of the mean value and the standard deviation or the multiple of the standard deviation of the normalized and normed distribution function.

Furthermore, it is conceivable to determine the general limit starting from the starting system. For this purpose, for example, the general limiting value (general limit) is calculated in that a starting threshold value relating to the distribution function, that is to say a starting value located in the starting system or defined in the starting system is converted on the basis of the transformation rule into the general limiting value relating to the normalized and normed distribution function, in such a way that the starting threshold value or starting value is offset using the transformation rule and thus transformed into the target system.

The invention enables, on the basis of the test bench and on the basis of the measurements of the sound level of the components carried out by the test bench, the general limiting value, also simply designated as the general limit, which is also designated as the first limit or first general limiting value, to be calculated and the calculated general limit to be used as the foundation for testing the components and/or other further components by means of the test bench and/or by means of another further test bench with regard to their sound level emitted at the same operating point, in such a way that results of the tests are very well comparable to one another, in particular as a function of the calculated general limiting value. If, for example, a first sound level emitted by one component at one operating point is thus measured by means of the test bench and if a second sound level emitted by the component at the same operating point is measured by means of another further test bench, the first sound level and the second sound level can be compared to one another as a function of the general limit or, because the first sound level and the second sound level are checked or assessed as a function of the general limit, it is possible to avoid the component being classified by means of the one test bench as sufficiently quiet or as in order and being classified by means of the other test bench as excessively loud or as not in order. Expressed in still other words, the invention enables the calculation of the general limiting value as an equivalent general limit, that is to say applicable or advantageously usable for different test benches, so that components can be tested equally well, i.e., comparably, by means of the test benches. This is to be understood in particular to mean that it is possible to come to the same test results on the basis of the calculated limit by way of different test benches, in particular in such a way that the same result with regard to the same component is or would be reached by means of both test benches. Therefore, for example, if components are to be checked by two test benches as to whether the components, in particular their sound level emitted at the same operating point, meet a criterion, which is in particular specifiable or specified, the invention enables both test benches to test or judge the same component at the same operating point identically, so that it can be determined on the basis of both test benches that the same component or its sound level meets the criterion or does not. Different assessments of the component by the test benches can be avoided by the invention.

The test bench, on the basis of which the general limit is calculated, is, for example, a so-called reference test bench, which is also designated as the master test bench. It is presumed here, for example, that the reference test bench can test the respective component sufficiently well, so that when it is determined on the basis of the reference test bench that the component or its sound level meets the criterion, this is also actually the case and the component can be used, for example, in a finished produced motor vehicle. The general limit calculated on the basis of the reference test bench can then be transferred to at least one or more other test benches, which are also designated as target test benches. It can be ensured by this transfer of the general limit to the respective target test bench that the respective target test bench can then also test the respective component or a respective other component sufficiently well that when it is determined by means of the respective target test bench that the respective component or its sound level meets the criterion, this is also actually the case and therefore the component can actually be used for a finished motor vehicle. The multiple of the standard deviation, i.e., n, is selected empirically, for example, so that the multiple of the standard deviation is specifiable or specified.

The method according to the invention is particularly advantageously usable for testing drive components, in particular drive assemblies, for motor vehicles. In other words, it is preferably provided that the component is a drive component, in particular a drive assembly, for a respective motor vehicle, preferably designed as an automobile. In particular, the component can be a motor, in particular an internal combustion engine or an electrical machine or a transmission (for use with an internal combustion engine or an electrical machine). In other words, for example, the component, in particular the drive component, can comprise a motor, in particular an internal combustion engine or an electrical machine, and/or a transmission for a motor vehicle. Preferred components or drive assemblies are electrical drive assemblies in which both the electrical machines and the transmission (comprising at least one transmission step and/or differential, etc.) are arranged in a housing.

To be able to test a particularly high number of components advantageously and in particular comparably, it is provided in one embodiment of the invention that a further limiting value, that is to say a further limit for a further other test bench, is calculated as a function of the limiting value. Alternatively or additionally, it can be provided that the limiting value is used for the further test bench. The invention thus initially provides in principle determining, i.e., finding, the general limit on the basis of the first test bench. In this way, an advantageous basis is created to test the components and/or other components, in particular with regard to their sound level. In addition, in this way a basis is created to be able to test the components and/or the further components on the basis of the at least one further test bench, in particular with regard to their sound level. In the above-described embodiment, it is then provided that the calculated first general limiting value is used to calculate the further limiting value for the further test bench and/or the calculated first general limiting value is used for the further test bench in order to test the components and/or other further components as a function of the calculated first general limiting value and/or as a function of the further limiting value by means of the further test bench.

In order to be able to test the components and/or the further components in a simple manner by means of the further test bench, it is provided in a further embodiment of the invention that further measured values are determined, in particular by means of a further or the electronic computing unit, which characterize respective further sound levels emitted by the components or by further components at the same operating point and measured by means of the further test bench. The statements above and hereinafter on the first measured values can be readily transferred to the further measured values and vice versa. Furthermore, it is provided that a further distribution function is calculated from the further measured values by means of the first electronic computing unit or by means of the further electronic computing unit and the further distribution function is normalized, in particular by means of the further electronic computing unit or by means of the first electronic computing unit, so that a further normalized distribution function is calculated. The further normalized distribution function is also designated as the further equal distribution or further equal distribution function.

Furthermore, a further mean value of the further normalized distribution function is calculated, in particular by means of the first electronic computing unit or by means of the further electronic computing unit. Furthermore, it is preferably provided that the standard deviation, also designated as the further standard deviation, of the further normalized distribution function is calculated, in particular by means of the first electronic computing unit or by means of the further electronic computing unit. In addition, a further transformation rule comprising the further standard deviation and the further mean value is determined, in particular by means of the first electronic computing unit or by means of the further electronic computing unit, on the basis of which each point of the further non-normalized distribution function is transformable into a point of the normalized and normed further distribution function, in order to thus generate the normalized and normed further distribution function from the points of the further non-normalized distribution function. This means that the further test bench is also characterized, in particular in the same way in which the first test bench was also characterized. It is thus apparent that fundamentally the same steps are carried out for the further test bench as for the first test bench (reference test bench), in order to characterize the test benches.

It has been shown to be particularly advantageous if the further limiting value is calculated, in particular by means of the first or further electronic computing unit, in that the general limiting value is converted on the basis of the inverted further transformation rule to the further limiting value relating to the further, non-normalized and non-normed distribution function. The general limit is thus converted to a further starting system or transformed into the further starting system in which the further non-normed and non-normalized distribution function, relating to the further test bench, is described or is located. Measured values which are obtained by means of the further test bench can thus be compared at least essentially directly and thus quickly and easily to the further limiting value.

In other words, a back transformation of the general limit and thus from the target system to the further limiting value and thus into the further starting system takes place, by which the components can be tested by means of the further test bench particularly quickly, precisely, and informatively. The further transformation rule is inverted for this back transformation. For example, all points of the normalized and normed further distribution function can be converted or transformed into points of the non-normalized and non-normed further distribution function on the basis of the inverted further transformation rule, and in particular the general limit can be back calculated in this way to the non-normalized and non-normed further distribution function.

Therefore, for example, the above-described normalizing and norming, also designated as transformation, of the further distribution function relating to the further test bench only has to be carried out once in order to characterize the further test bench and thus be able to relate or back calculate the general limit obtained on the basis of the reference test bench to the further test bench. Back calculation from the general limit to the further limiting value is carried out by a corresponding inverse procedure, so that, for example, sound levels or measured values which characterize sound levels emitted by components at the same operating point and are measured by means of the further test bench can be compared to the calculated further limiting value without the above-described transformation, i.e., without the normalizing and norming and in particular directly. Components which are tested by means of the further test bench (target test bench) can thus be tested quickly and precisely as to whether the respective component or its sound level exceeds the further limiting value or not. If the component or its sound level or the measured value characterizing the sound level exceeds the further limiting value, the component thus does not meet the criterion and the component is excessively loud or has an undesired noise behavior, since the component emits undesired noises. However, if the sound level or the measured value characterizing the respective sound level of the respective component is less than or equal to the further limiting value, the component is thus sufficiently quiet or the component has an advantageous noise behavior, so that the component meets the criterion. The method makes it possible that both test benches, i.e., both the reference test bench and the target test bench, for example, when the same component was tested at the same operating point by means of both test benches, come to the same result or would come to the same result, i.e., it can or could be determined by means of both test benches whether the respective component meets the criterion or not. The criterion is not met, for example, if the sound level measured by means of the further test bench or the measured value characterizing the sound level exceeds the further limiting value, so that the criterion is at least met, for example, if the sound level measured by means of the further test bench or the measured value characterizing the sound level falls below the further limiting value or is equal to the threshold value. It is apparent that the further limiting value is a first limit relating to the further test bench, which is thus specific. The starting threshold value is a second limit, which relates to the first test bench and is thus specific, and on the basis of which the general limit usable for both test benches can be determined, from which it is then possible to calculate back to the first specific limit.

In order to finally be able to test components particularly advantageously and comparably as a function of the calculated general limit and as a function of the calculated further limiting value, it is provided in a further embodiment of the invention that third measured values are measured by means of the further test bench, which characterize third sound levels, which are emitted at the same operating point by the components and/or the further components and/or third components, wherein the third measured values are tested on the basis of the further limiting value and/or compared to the further limiting value. It is thus conceivable that the first components and the further components are used to determine the equivalent general limit. After corresponding determination of the general limit and the specific first limit, still other components in the form of the third components can advantageously be tested by means of the target test bench (further test bench). The invention thus enables the target test bench to test the third components as a function of the further limiting value, so that the target test bench tests the third components as the reference test bench would have. This means that the target test bench comes to the same results or that the same results are arrived at on the basis of the target test bench, to which the reference test bench would also come or which would also be arrived at on the basis of the reference test bench.

In order to be able to test the components particularly advantageously, it is provided in a further embodiment of the invention that the arithmetic mean value is calculated as the mean value.

A second aspect of the invention relates to a method for testing at least one component. In the method according to the second aspect of the invention, the component is operated at at least one operating point, in which the component emits a sound level, by means of a test bench. At least one measured value, which characterizes the emitted sound level, is measured by means of the test bench. The measured value is tested here as a function of a limiting value calculated by means of a method according to the first aspect of the invention. This is to be understood to mean, for example, that the measured value is compared to the limiting value or the measured value is compared to the further limiting value. Advantages and advantageous embodiments of the first aspect of the invention are to be viewed as advantages and advantageous embodiments of the second aspect of the invention and vice versa.

The invention furthermore relates to a method for producing a component, wherein a method according to the invention for testing is used. Preferred components are mentioned above.

Further details of the invention result from the following description of a preferred exemplary embodiment with the associated drawings.

### BRIEF DESCRIPTION OF THE DRAWINGS

FIG. 1 shows a flow chart to illustrate a method according to the invention; and

FIG. 2 shows a further diagram to further illustrate the method.

### DETAILED DESCRIPTION OF THE DRAWINGS

In the figures, identical or functionally identical elements are provided with identical reference signs.

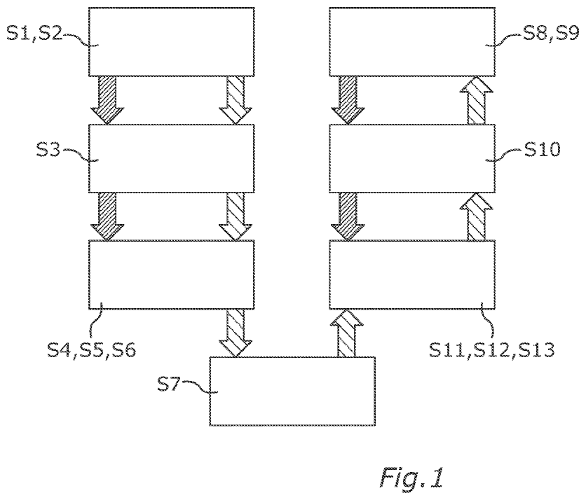

FIG. 1 shows a flow chart, on the basis of which a method for characterizing a first test bench is illustrated hereinafter. The first test bench is a reference test bench, also designated as the master test bench, which is designed to measure sound levels of first components for motor vehicles, i.e., sound levels emitted from components of motor vehicles. The respective component is, for example, a drive component, which can comprise an internal combustion engine and/or a transmission. The reference test bench is also designated as the end of line test bench, since it is used, for example, at the end of an assembly line or an assembly belt in order to test the respective component produced along the assembly line or along the assembly belt or its sound level. This takes place, for example, in such a way that the component is operated by means of the reference test bench at an operating point. The operating point is defined, for example, by a speed of the component. This means that the component includes at least one shaft and at least one housing, wherein the shaft is rotatable relative to the housing around an axis of rotation. The shaft is driven by means of the reference test bench and thus rotated around the axis of rotation relative to the housing in such a way that the shaft rotates at a speed specifiable or specified in particular by the test bench. The reference test bench measures the sound level which is emitted by the component while the shaft is rotated at the speed. The sound level is, for example, a level of a sound emitted by the component, wherein the sound can be a structure-borne sound and/or an airborne sound. The sound or the sound level is therefore acquired, for example, by means of a structure-borne sound sensor or by means of a microphone of the test bench. It is conceivable here in particular that the shaft is rotated by means of the test bench at different speeds, so that the component is operated by means of the test bench at different operating points, wherein it is preferably provided that for each of the speeds or for each of the operating points, a respective sound level emitted by the component at the operating point or a respective measured value is measured by means of the test bench, which characterizes a respective sound level which is emitted by the component at the respective operating point. In order to explain the method clearly hereinafter, reference is made to a speed, i.e., to an operating point, a sound level, and an associated measured value. In particular, it is conceivable that at least one order or different orders of the component are acquired and tested by means of the test bench. It is thus conceivable in particular that an order analysis is carried out by means of the reference test bench, i.e., an analysis of noises and/or oscillations of the component. Alternatively or additionally, a frequency analysis is carried out.

In a first step S1 of the method, measured values are determined which characterize the sound levels emitted by the first components at the same operating point and measured by means of the first test bench (reference test bench).

In a second step S2 of the method, a distribution function is determined from the measured values. In a third step S3 of the method, the distribution function is normalized, for example by means of a Box-Cox transformation. The normalization of the distribution function is to be understood to mean that a normal distribution is formed from the distribution function. In a fourth step S4 of the method, a or the mean value, in particular the arithmetic mean value, of the normalized distribution function is calculated. In a fifth step S5 of the method, the standard deviation of the normalized distribution function is calculated. The normalization of the distribution function is carried out by means of a mathematical instrument, for example the Box-Cox transformation. In a sixth step S6 of the method, a transformation rule comprising the standard deviation and the mean value and also the instrument is determined, on the basis of which each point of the original, non-normalized and non-normed distribution function is transformable into a point of the normalized and normed distribution function, in order to thus generate the normalized and normed distribution function from the points of the non-normalized and non-normed distribution function. The transformation rule thus comprises the instrument for normalizing the original, non-normalized distribution function and a norming rule for norming the normalized distribution function. The norming rule comprises, for example, that each point of the normalized and not yet normed distribution function is thus converted into a respective point of the normalized and normed distribution function and the normalized distribution function can thus be converted into the normalized and normed distribution function in that the respective difference between the respective point of the normalized distribution function and the mean value of the normalized distribution function is divided, i.e., split, by the standard deviation of the normalized distribution function.

In a seventh step S7, at least one general limiting value relating to the normalized distribution function is calculated, which is also designated as the general or equivalent limit. For example, the general limiting value is calculated in that a starting threshold value relating to the original, non-normed and non-normalized distribution function is converted, therefore transformed, on the basis of the transformation rule into the general limiting value relating to the normalized and normed distribution function.

The reference test bench is a test bench which has proven to be capable, in particular by tests, of being able to test components for motor vehicles in such a way that when it is determined by means of the reference test bench that a sound level of a component is sufficiently low, this component can actually be installed in a motor vehicle without undesired noises caused by the component occurring in the state of the component installed in the motor vehicle. In order to now also be able to test components for motor vehicles by means of another further test bench also designated as the target test bench in such a way that the target test bench can test the components just as well as the reference test bench, that is to say when a component is tested by means of the target test bench, it arrives at the same results as when the component was tested by means of the reference test bench, the general limiting value is used in order to test further or second components as a function of the general limiting value by means of the target test bench, which is also designated as the second or further test bench.

It is provided for this purpose in an eighth step S8 that further or second measured values are determined which characterize respective further or second sound levels emitted by the first components or by further or second components at the same operating point and measured by means of the target test bench. For this purpose, the respective component or the respective further component is tested by means of the target test bench in such a way that the respective component or the respective further component is operated in the same operating state by means of the target test bench and a respective further measured value is measured by means of the target test bench for the respective component, which characterizes a respective further sound level, which is emitted by the respective component or further component, while the respective component or further component is operated at the operating point by means of the test bench.

The target test bench is now characterized like the reference test bench. As in second step S2, it is thus provided in a ninth step S9 that a further or second distribution function is calculated from the further or second measured values. In a tenth step S10, it is provided that the further distribution function is normalized, and in an eleventh step S11, it is provided that a further or second mean value of the further or second normalized distribution function is calculated. In a twelfth step, the standard deviation of the further normalized distribution function is calculated, and in a thirteenth step S13, a further transformation rule is determined, comprising the further standard deviation and the further mean value and an instrument for normalizing the further distribution function, on the basis of which each point of the further non-normalized and non-normed distribution function is transformable into a point of the normalized and normed further distribution function, in order to thus generate the normalized and normed further distribution function from the points of the further non-normed and non-normalized distribution function. The instrument for normalizing the further distribution function can be the Box-Cox transformation.

A further or second limiting value, i.e., a further or second limit, is then calculated for the reference test bench in that the general limiting value is converted, therefore transformed, on the basis of the inverted further transformation rule to the further limiting value relating to the further, non-normalized and non-normed distribution function.

By inverting the further transformation rule, a back transformation rule is obtained, on the basis of which the general equivalent limit can be calculated back to the further limiting value. A or the respective further measured value measured or to be measured by the target test bench is comparable to the further limiting value. In other words, the further limiting value is such a comparison value, which can be used, for example, in the following manner: By means of the target test bench, for example, third components are tested in the above-described manner, in such a way that the respective third component is operated by means of the target test bench at the respective operating point, wherein a respective third measured value is measured by means of the target test bench for the respective third component, which characterizes a respective third sound level, which is emitted by the respective third component at the operating point. The respective third measured value can now be compared, in particular directly, to the comparison value. If the respective third measured value is, for example, greater than the comparison value (further limiting value), it can then be inferred that the respective third component is excessively loud or emits undesired noises. If the respective third measured value is less than or equal to the comparison value, however, the third component is thus sufficiently quiet or the third component has an advantageous noise behavior, so that the third component can actually be installed on the motor vehicle. One would arrive at the same results if the respective third component were tested by means of the target test bench, since the further limiting value was determined from the equivalent limit determined on the basis of the reference test bench. Therefore, components can be tested precisely and comparably and in particular equally well both by means of the reference test bench and by means of the target test bench, so that those components which are classified as suitable for installation in a motor vehicle by the target test bench are also classified for installation in a motor vehicle by the reference test bench and vice versa.

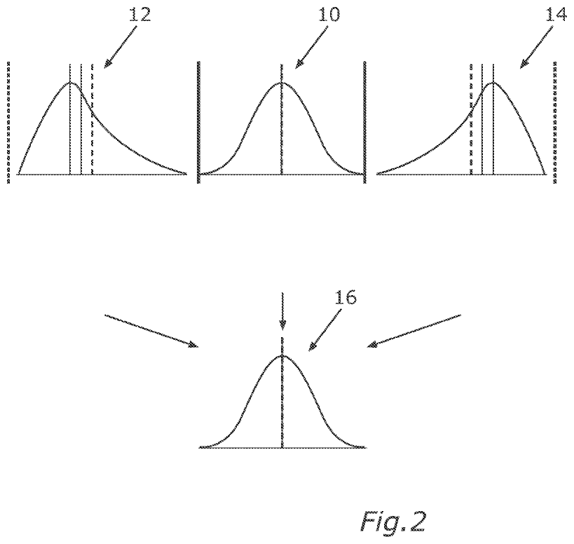

FIG. 2 shows a diagram to illustrate the method, in particular to illustrate the normalizing. FIG. 2 shows a distribution function designated by 10 and formed as a normal distribution. In addition, FIG. 2 shows a distribution function designated by 12, which is a skewed distribution and thus a distribution function different from the normal distribution. In addition, FIG. 2 shows a distribution function 14 which is also a skewed distribution and thus a distribution function different from a normal distribution. It is illustrated by arrows in FIG. 2 that by the described normalization, i.e., for example, by the Box-Cox transformation, the skewed distributions (distribution functions 12 and 14) can be converted into a normal distribution designated by 16 in FIG. 2. If, for example, the distribution function 10 is subjected to the Box-Cox transformation, i.e., the normalization, although the distribution function 10 is already a normal distribution, no unfavorable change of the distribution function 10 takes place and the distribution function 10 remains a or the normal distribution. The method therefore enables distribution functions different from the normal distribution to be advantageously converted into a normal distribution, without unfavorably changing distribution functions already formed as normal distributions, however. The method therefore enables components to be able to be tested equally well by means of the reference test bench and by means of the target test bench. In other words, by way of the method, it is possible to avoid the test benches arriving at different results when the same component is tested at the same operating point.

### LIST OF REFERENCE CHARACTERS

10 distribution function
12 distribution function
14 distribution function
16 normal distribution
S1 first step
S2 second step
S3 third step
S4 fourth step
S5 fifth step
S6 sixth step
S7 seventh step
S8 eighth step
S9 ninth step

1.-11. (canceled)

12. A method for characterizing a test bench designed for measuring sound levels of components, comprising the steps of:
determining measured values which characterize respective sound levels emitted by the components at a same operating point and which are measured by the test bench;
calculating a distribution function from the measured values;
normalizing the distribution function;
calculating a mean value of the normalized distribution function; and
calculating a standard deviation of the normalized distribution function.

13. The method according to claim 12, wherein a transformation rule comprising the standard deviation and the mean value is determined and wherein on a basis of the transformation rule each point of the distribution function is transformable into a point of a normalized and normed distribution function in order to generate the normalized and normed distribution function from each point of the distribution function.

14. The method according to claim 13, further comprising the step of calculating a general limiting value.

15. The method according to claim 14, wherein the general limiting value is calculated in that a mean value of the normalized and normed distribution function is added to a standard deviation of the normalized and normed distribution function or a multiple of the standard deviation of the normalized and normed distribution function.

16. The method according to claim 14, wherein the general limiting value is calculated in that a starting threshold value relating to the distribution function is converted on a basis of the transformation rule into the general limiting value relating to the normalized and normed distribution function.

17. The method according to claim 14, wherein as a function of the general limiting value, a further limiting value is calculated for a further test bench and/or the general limiting value is used for the further test bench.

18. The method according to claim 17, further comprising the steps of:
determining further measured values which characterize respective further sound levels emitted by the components or by further components at the same operating point and measured by the further test bench;
calculating a further distribution function from the further measured values;
normalizing the further distribution function;
calculating a further mean value of the further normalized distribution function;
calculating a further standard deviation of the further normalized distribution function; and
determining a further transformation rule comprising the further standard deviation and the further mean value, wherein on a basis of the further transformation rule each point of the further distribution function is transformable into a point of a normalized and normed further distribution function in order to generate the normalized and normed further distribution function from each point of the further distribution function.

19. The method according to claim 18, wherein the further limiting value is calculated in that the general limiting value is converted on a basis of an inverted further transformation rule to the further limiting value relating to the further distribution function.

20. The method according to claim 18, wherein third measured values are measured by the further test bench which characterize respective third sound levels which are emitted at the same operating point by the components and/or the further components and/or the third components and wherein the third measured values are tested on a basis of the further limiting value and/or compared to the further limiting value.

21. A method for testing a component, comprising the steps of:
operating the component at an operating point at which the component emits a sound level by a test bench;
measuring a measured value which characterizes the emitted sound level by the test bench; and
testing the measured value as a function of a limiting value calculated by the method according to claim 12.

22. A method for producing a component, wherein the method according to claim 21 is used for testing.
